(19) United States
(12) Patent Application Publication
(10) Pub. No.: US 2014/0041442 A1
(43) Pub. Date: Feb. 13, 2014

(54) Arrangement And Method For Determining A Concentration Of A Constituent Of A Fluid Mixture

(71) Applicants: Stephan Heinrich, Pfeffenhausen (DE); Markus Herrmann, Regensburg (DE); Torsten Reitmeier, Wackersdorft (DE); Denny Schädlich, Neustadt (DE)

(72) Inventors: Stephan Heinrich, Pfeffenhausen (DE); Markus Herrmann, Regensburg (DE); Torsten Reitmeier, Wackersdorft (DE); Denny Schädlich, Neustadt (DE)

(21) Appl. No.: 14/002,977

(22) PCT Filed: Mar. 1, 2012
(86) PCT No.: PCT/EP12/53510

§ 371 Date: Oct. 22, 2013

(30) Foreign Application Priority Data
Mar. 3, 2011 (DE) 102011012992.8

(51) Int. Cl. G01N 29/028

(52) U.S. Cl. CPC G01N 29/028
USPC 73/61.79

(57) ABSTRACT

A method and arrangement for determining a concentration of a constituent of a fluid mixture in a fluid chamber includes: emitting an ultrasonic pulse into the fluid mixture, receiving a reflection of the ultrasonic pulse as a measurement signal after the ultrasonic pulse has been reflected at at least two impedance jumps, determining the concentration of the constituent of the fluid mixture on the basis of the measurement signal.

### CROSS REFERENCE TO RELATED APPLICATIONS

This is a U.S. national stage of application No. PCT/EP2012/053510, filed on Mar. 1, 2012. Priority is claimed on German Application No.: DE102011012992.8, filed Mar. 3, 2011, the content of which is incorporated herein by reference.

### BACKGROUND OF THE INVENTION

1. Field of the Invention

The invention relates to a method for determining a concentration of a constituent of a fluid mixture. The invention furthermore relates to a corresponding arrangement for determining a concentration of a constituent of a fluid mixture.

2. Description of the Prior Art

Using ultrasound it is possible to identify liquids by their characteristic speed of sound (pulse-echo method). To this end, the travel time an ultrasound requires for a predetermined path length is measured. To distinguish between different concentrations of a liquid mixture, or different liquids, the time of flight difference is evaluated. This time of flight difference lies in the microsecond range. The longer the time of flight, the greater the difference in the time of flight difference for equal concentrations.

In motor vehicles, the pulse-echo method is used for example for filling level measurement to determine a quantity of a fluid in a tank. The pulse-echo method is furthermore used in order to determine the concentration of fluid mixtures, in particular two-component mixtures.

In order to obtain a concentration resolution, which is as good as possible, it is necessary to provide a path length that is as long as possible.

U.S. Pat. No. 5,650,571 presents various embodiments of the use of energy-saving signal processing. A filling level measurement using ultrasound is described in one exemplary embodiment and a concentration measurement by ultrasound in another.

B. Henning et al. “In-line concentration measurement in complex liquids using ultrasonic sensors”, Ultrasonics (2000) 799-803 and J. A. Bamberger, M. S. Greenwood “Measuring fluid and slurry density and solids concentration non-invasively”, Ultrasonics, 42 (2004) 563-567 respectively describe a sensor system for characterizing liquid mixtures, in which, for the measurement, an ultrasound pulse is respectively reflected alternately at two sonic transducers arranged opposite each other, and the reflections are evaluated.

### SUMMARY OF THE INVENTION

It is desirable to specify a method and a corresponding arrangement that make it possible to reduce the size of the installation space and permit high accuracy in the above evaluation.

The invention is distinguished by a method and by an arrangement which is suitable for carrying out the method.

In one embodiment, to determine a concentration of a constituent of a fluid mixture in a fluid space, an ultrasound pulse is emitted into the fluid mixture. A reflection of the ultrasound pulse is received as a measurement signal after the ultrasound pulse has been reflected at at least two impedance discontinuities, one impedance discontinuity of the two impedance discontinuities being formed by an interface of the fluid mixture with air. The concentration of the constituent of the fluid mixture is determined as a function of the measurement signal.

The geometry of the fluid space is, in particular, predetermined by the installation situation of the arrangement. The total path traveled by the ultrasound pulse between emission and reception of the reflection is extended by the reflection at at least two impedance discontinuities in the predetermined geometry of the fluid space. The travel time of the ultrasound pulse between emission and reception is therefore also extended. In this way, the accuracy when determining the concentration of the constituent of the fluid mixture in the predetermined geometry of the installation space is increased in comparison with a single reflection at only one impedance discontinuity.

For a predetermined accuracy for the determination of the concentration, it is possible to reduce the size of the fluid space while preserving the accuracy.

In other embodiments, the reflection is received after the ultrasound pulse has respectively been reflected alternately a plurality of times at the at least two impedance discontinuities. For example, the ultrasound pulse is reflected at least eleven times in total. In particular, the reflection is received after the ultrasound pulse has been reflected six times at the first impedance discontinuity, at which it is reflected first, of the two impedance discontinuities, and has respectively been reflected at the second impedance discontinuity of the two impedance discontinuities between two reflections at the first impedance discontinuity.

In this way, the total path and therefore the travel time can be extended further, so that the accuracy when determining the concentration is further increased, or the size of the fluid space can be reduced further.

In one embodiment, the arrangement comprises an ultrasonic transducer and a control unit for operating the ultrasonic transducer. The ultrasonic transducer is adapted to emit the ultrasound pulse into the fluid mixture. The ultrasonic transducer is furthermore adapted to receive the reflection as a measurement signal. The control unit is adapted to provide a signal for the ultrasonic transducer, so that the ultrasonic transducer emits the ultrasound pulse. Furthermore, the control unit is adapted to determine the concentration of the constituent of the fluid mixture as a function of the measurement signal.

The two impedance discontinuities are arranged, in particular, so that the ultrasound pulse is reflected at the first impedance discontinuity such that the ultrasound pulse strikes the further impedance discontinuity after reflection at the impedance discontinuity.

The at least two impedance discontinuities are arranged so that the ultrasound pulse is reflected at the further impedance discontinuity in such a way that the ultrasound pulse strikes the impedance discontinuity again after reflection at the further impedance discontinuity. In this way, it is possible for the ultrasound to be reflected more than twice when there are two impedance discontinuities, so that the total path and therefore the time of flight of the ultrasound pulse can be extended.

In particular, the further impedance discontinuity is arranged locally in a region of the ultrasonic transducer in the fluid space. For example, the further impedance discontinuity is on a surface of the ultrasonic transducer, so that the ultrasound pulse is reflected at the ultrasonic transducer.

Other advantages, features and refinements may be found in the example explained below in conjunction with FIG. 3. The elements represented and the size ratio between them are not in principle to be regarded as true to scale.

### BRIEF DESCRIPTION OF THE DRAWINGS

FIG. 1 is a schematic representation of an arrangement according to one embodiment;

FIG. 2 is the profile of the received reflections; and

FIG. 3 is a schematic representation of an arrangement according to a further embodiment.

### DETAILED DESCRIPTION OF THE PRESENTLY PREFERRED EMBODIMENTS

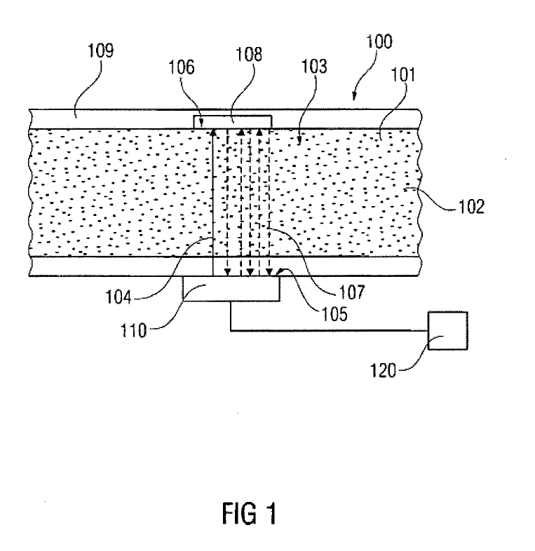

FIG. 1 shows a schematic representation of an arrangement 100. The arrangement 100 comprises an ultrasonic transducer 110. The arrangement 100 furthermore comprises a control unit 120 for operating the ultrasonic transducer 110.

The ultrasonic transducer 110 is an ultrasound source which also acts as an ultrasonic receiver. In one embodiment, the ultrasound source and the ultrasonic receiver are separate components.

The control unit 120 is coupled to the ultrasonic transducer 110. The control unit 120 is adapted to provide signals for operating the ultrasonic transducer 110, so that the ultrasonic transducer 110 emits an ultrasound pulse as a function of the signals. The control unit 120 is furthermore adapted to receive measurement signals from the ultrasonic transducer 110.

The ultrasonic transducer 110 is arranged on a fluid space 103. The fluid space 103 is enclosed by walls 109. The fluid space 103 is at least partially filled with a fluid mixture 101.

The fluid mixture 101 comprises, for example, two constituents. The concentration of one constituent 102 of the two constituents is determined. For example, the fluid mixture 101 is a mixture of urea and water, which is used for after-treatment of exhaust gases of a motor vehicle in an SCR catalyst (SCR: selective catalytic reduction). In this example, the constituent 102 of the fluid mixture 101 is urea.

Two impedance discontinuities 105 and 106 are arranged in the fluid space 103. The first impedance discontinuity 105 in the exemplary embodiment shown is that surface of the ultrasonic transducer 110 that faces toward the fluid space 103. The second impedance discontinuity 106 is arranged opposite the first impedance discontinuity 105 in the fluid space 103, so that an ultrasound pulse 104, which is emitted by the ultrasonic transducer 110, is reflected to and fro between the two impedance discontinuities 105 and 106.

In the exemplary embodiment shown in FIG. 1, the ultrasonic transducer 110 is arranged on one of the walls 109 and emits the ultrasound pulse through the wall 109 into the fluid mixture 101. In further embodiments, the ultrasonic transducer 110 is arranged in the fluid space 103 so that it is in contact with the fluid mixture 101. It is furthermore possible to mount the ultrasonic transducer 110 on a pipe through which the fluid mixture 101 flows, the ultrasonic transducer being mounted in such a way that the ultrasound pulse 104 is emitted transversely with respect to the flow direction of the fluid mixture 101.

The ultrasound pulse 104 is emitted by the ultrasonic transducer 110 and is reflected back at the impedance discontinuity 106 to the ultrasonic transducer 110, or the impedance discontinuity 105. In the exemplary embodiment shown, the wall 109 of the fluid space 103 lying opposite the ultrasonic transducer 110 is used as the impedance discontinuity 106. A sonic reflector 108 is optionally arranged to amplify the reflection.

After the ultrasound pulse has been reflected at the impedance discontinuity 106, it is reflected to the impedance discontinuity 105. The ultrasound pulse is reflected at the impedance discontinuity 105 in such a way that it again strikes the impedance discontinuity 106, at which it is reflected once more. The ultrasound pulse subsequently strikes the ultrasonic transducer 110 for a second time. This is repeated until the ultrasound pulse has decayed.

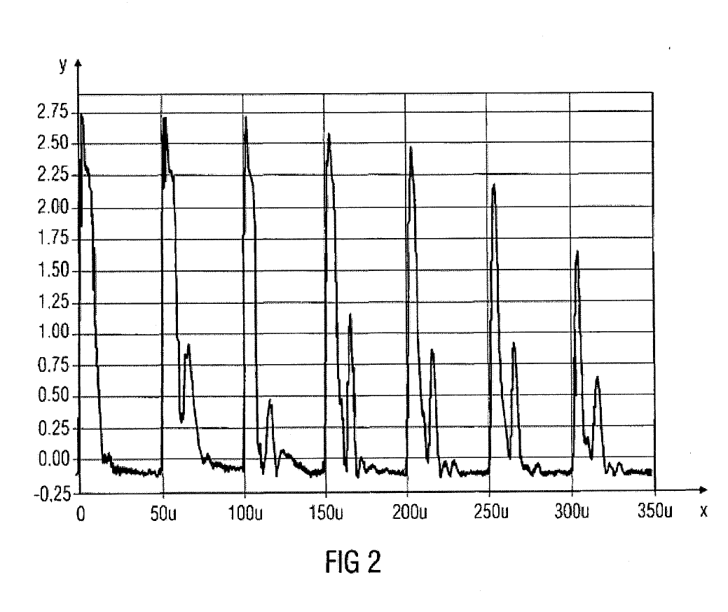

The emission and reception of the first six reflections by the ultrasonic transducer 110 is represented in FIG. 2. The ultrasound pulse 104 is emitted in the range of from about 0 seconds to about 20 microseconds. The first reflection reaches the sensor after about 50 microseconds. The further reflections reach the ultrasonic transducer 110 about every 50 microseconds.

The control unit 120 determines the concentration of the constituent 102 of the fluid mixture 101 as a function of a measurement signal, which is obtained from a received reflection 107 that has been reflected at least once at the impedance discontinuity 106 and at least once at the impedance discontinuity 105. The control unit 120 determines the concentration of the constituent 102 of the fluid mixture 101 as a function of a measurement signal obtained from the second received reflection or a subsequent received reflection.

The total path length that the ultrasound pulse travels between the emission and the reception of the reflection which is used by the control unit 120 is obtained from the reflection used for the evaluation. If the second incident reflection is used for determining the concentration of the constituent, the total path is four times the distance between the two impedance discontinuities 105 and 106. If the sixth incident reflection is used for the evaluation, the total path is twelve times the distance between the two impedance discontinuities 105 and 106.

If the distance is 36 millimeters, for example, the total path when evaluating the sixth incident reflection is 432 millimeters.

In general, the total path is twice the distance between the two impedance discontinuities 105 and 106 multiplied by the number of the received reflection which is used for determining the concentration of the constituent 102 of the fluid mixture 101.

The time that elapses between the emission of the ultrasound pulse 104 and the reception of the reflection 107 is measured by the control unit 120. The reflection 107 is the received reflection used as a measurement signal for determining the concentration of the constituent 102. The speed of sound in the fluid mixture 101 is determined from the time that is measured and the total determined path. The speed of sound is characteristic of the concentration of the constituent 102 in the fluid mixture 101, so that the concentration of the constituent can be determined from the speed of sound.

In one embodiment, the number of the received reflection 107 used for determining the concentration is predetermined. The total path is therefore known, so that the concentration is determined as a function of the time of flight.

By using the second incident reflection as a measurement signal for determining the concentration, or a subsequent incident reflection as the measurement signal, the total path and therefore the time of flight of the ultrasound pulse are increased in comparison with a conventional method in which the first incident reflection is used. The accuracy when determining the concentration is therefore increased since, with a longer time of flight, the time of flight differences for different concentrations of the constituent are greater.

With a constant predetermined accuracy, by evaluating the second incident reflection or a subsequent incident reflection it is possible to reduce the size of the installation space of the fluid space 103, for example to reduce the distance between the two impedance discontinuities 105 and 106.

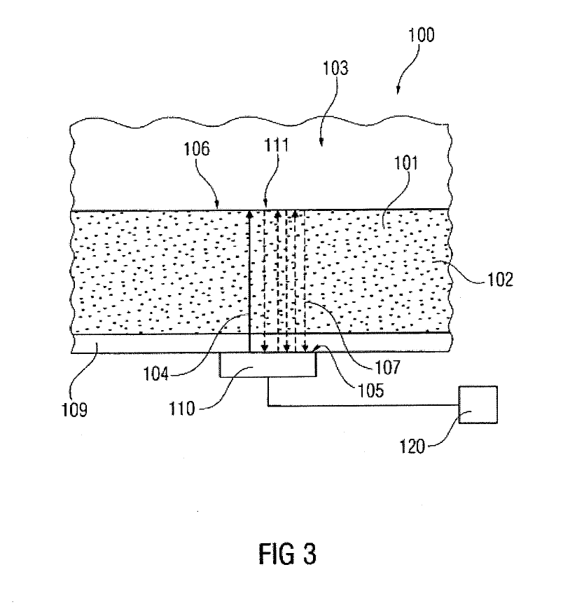

FIG. 3 shows the arrangement 100 of FIG. 1 according to a further embodiment. In contrast to FIG. 1, the impedance discontinuity 106 is not arranged on an opposite wall of the fluid space, but is an interface 111 of the fluid mixture 101 with another medium, in particular air. According to this exemplary embodiment, the ultrasonic transducer 110 and the control device 120 are also used to determine the filling level of the fluid mixture 101 in the fluid space 103, in addition to the concentration determination.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-10. (canceled)

11. A method for determining a concentration of a constituent of a fluid mixture in a fluid space, comprising:
emitting an ultrasound pulse into the fluid mixture;
receiving a reflection of the ultrasound pulse as a measurement signal after the ultrasound pulse has been reflected at at least two impedance discontinuities, wherein one impedance discontinuity of the two impedance discontinuities is an interface of the fluid mixture with air; and
determining of the concentration of the constituent of the fluid mixture as a function of the measurement signal.

12. The method as claimed in claim 11, comprising:
receiving the reflection after the ultrasound pulse has been reflected a plurality of times at the at least two impedance discontinuities.

13. The method as claimed in claim 11, comprising:
Receiving the reflection after the ultrasound pulse has been reflected at least 11 times at the at least two impedance discontinuities.

14. An arrangement comprising:
an ultrasonic transducer; and
a control unit configured to operate the ultrasonic transducer, by
emitting an ultrasound pulse into a fluid mixture;
receiving a reflection of the ultrasound pulse as a measurement signal after the ultrasound pulse has been reflected at at least two impedance discontinuities, wherein one impedance discontinuity of the two impedance discontinuities is an interface of the fluid mixture with air; and
determining a concentration of a constituent of the fluid mixture as a function of the measurement signal.

15. The arrangement as claimed in claim 14, wherein the at least two impedance discontinuities are arranged so that the ultrasound pulse is reflected at the impedance discontinuity such that the ultrasound pulse strikes a further impedance discontinuity of the at least two impedance discontinuities after reflection at one impedance discontinuity of the at least two impedance discontinuities.

16. The arrangement as claimed in claim 14, wherein the at least two impedance discontinuities are arranged so that the ultrasound pulse is reflected at the further impedance discontinuity such that the ultrasound pulse strikes the impedance discontinuity again after reflection at the further impedance discontinuity.

17. The arrangement as claimed in claim 14, wherein the ultrasound pulse is emitted by the ultrasonic transducer arranged on a fluid space, and the reflection is received by the ultrasonic transducer, the further impedance discontinuity arranged locally in a region of the ultrasonic transducer in the fluid space.

18. The arrangement as claimed in claim 14, wherein there is a distance between the ultrasonic transducer and the impedance discontinuity, and the control unit is configured to determine the concentration of the constituent of the fluid mixture as a function of a total path given by the distance and a number of reflections at the at least two impedance discontinuities.

19. The arrangement as claimed in claim 14, wherein the ultrasonic transducer is arranged such that the ultrasound pulse is reflected at a wall of a fluid space.

20. The arrangement as claimed in claim 14, wherein the ultrasonic transducer is arranged such that the ultrasound pulse is reflected at an interface of the fluid mixture with air.

21. The method as claimed in claim 12, comprising:
Receiving the reflection after the ultrasound pulse has been reflected at least 11 times at the at least two impedance discontinuities.

22. The arrangement as claimed in claim 15, wherein the at least two impedance discontinuities are arranged so that the ultrasound pulse is reflected at the further impedance discontinuity such that the ultrasound pulse strikes the impedance discontinuity again after reflection at the further impedance discontinuity.

23. The arrangement as claimed in claim 22, wherein the ultrasound pulse is emitted by the ultrasonic transducer arranged on a fluid space, and the reflection is received by the ultrasonic transducer, the further impedance discontinuity arranged locally in a region of the ultrasonic transducer in the fluid space.

24. The arrangement as claimed in claim 23, wherein there is a distance between the ultrasonic transducer and the impedance discontinuity, and the control unit is configured to determine the concentration of the constituent of the fluid mixture as a function of a total path given by the distance and a number of reflections at the at least two impedance discontinuities.

25. The arrangement as claimed in claim 24, wherein the ultrasonic transducer is arranged such that the ultrasound pulse is reflected at a wall of the fluid space.

26. The arrangement as claimed in claim 25, wherein the ultrasonic transducer is arranged such that the ultrasound pulse is reflected at an interface of the fluid mixture with air.
